(19) United States
(12) Patent Application Publication
(10) Pub. No.: US 2025/0370163 A1
(43) Pub. Date: Dec. 4, 2025

(54) SOLAR IRRADIANCE NOWCASTING SYSTEM AND ADAPTIVE MAINTENANCE METHOD THEREOF FOR SOLAR IRRADIANCE NOWCASTING MODEL

(71) Applicants: LITE-ON SINGAPORE PTE. LTD., Singapore (SG); NANYANG TECHNOLOGICAL UNIVERSITY, Singapore (SG)

(72) Inventors: Nitin Gururaj Kallur, Singapore (SG); Nivethitha Somu, Singapore (SG); krishna kumar GOVINDASAMY, Singapore (SG); Dasappa Nirupam SANNAGOWDARA, Singapore (SG)

(21) Appl. No.: 18/985,875

(22) Filed: Dec. 18, 2024

Related U.S. Application Data
(60) Provisional application No. 63/653,372, filed on May 30, 2024.

(51) Int. Cl. G01W 1/10; G01W 1/18

(52) U.S. Cl. CPC G01W 1/10; G01W 1/18; G01W 2203/00

(57) ABSTRACT

A solar irradiance nowcasting system is provided. The system includes a storage unit and a processing unit. The storage unit is configured to store a structured dataset, an unstructured dataset, and a solar irradiance nowcasting model. The processing unit generates predicted GHI values based on current sky images using the model and adaptively maintains the model by executing operations including accumulating recent sky images and corresponding GHI data into the datasets, periodically checking if their accumulated number reaches a specified threshold, and initiating retraining upon reaching the threshold. The retraining process involves using the accumulated recent sky images and GHI data to update the model, ensuring accurate and up-to-date predictions.

### CROSS REFERENCE TO RELATED APPLICATIONS

This application claims the benefit of U.S. Provisional Application No. 63/653,372, filed May 30, 2024, the entirety of which is incorporated by reference herein.

### BACKGROUND OF THE INVENTION

### Field of the Invention

The present invention relates to machine learning and its application in solar irradiance nowcasting, and, in particular, to a solar irradiance nowcasting system and adaptive maintenance method thereof for the solar irradiance nowcasting model.

### Description of the Related Art

Energy crisis and environmental pollution have become a prominent and major problem that impels the world leading government bodies to focus on various actions to mitigate the effect of global warming. The integration of Renewable Energy Sources (RESs) into the energy matrix is one of the most effective ways to replace the carbon-intensive energy sources.

Solar energy is one of the most abundant and prominent RESs which can make the energy system resilient. However, photovoltaic (PV) power generation is unstable, intermittent, and highly influenced by solar irradiance, i.e., the incidence of solar rays on the PV panels and uncontrollable factors such as intensity and duration of the solar radiation, climate condition of the solar farm, wind speed, and cloud cover. Rapid changes in the solar irradiation results in demand-generation imbalance, power quality, voltage fluctuations and stability issues. As a result, the variation in the solar energy generated by the PV cells imposes challenge on grid operators (requiring reliable production estimates for safe supply) and utility companies (requiring grid load estimates to schedule, dispatch, and regulate power) in the power transmission system. Therefore, accurate solar irradiance nowcasting is pivotal to curb the economic inefficiencies and disruption in PV power generation and provide significant benefits to generators (in terms of proper management and maximum income), grid operators (in terms of proper grid planning, load-generation balance, and improved power quality), and end-users (in terms of profitable energy transactions).

Though PV power generation and solar irradiance are highly correlated, solar irradiance is the commonly used target variable of solar forecasting due to privacy and energy security concerns involved in accessing PV data. Global Horizontal Irradiance (GHI), the total irradiance incident on the horizontal surface to the earth's surface, which includes Direct Normal Irradiance (DNI) and Diffuse Horizontal Irraduance (DHI) components forms the most important parameter to calculate the PV power generation.

The state-of-the-art solar nowcasting approaches focuses on the improvements in the image processing techniques and deep learning models. However, these methods often rely on pre-trained models that are static in nature, failing to account for the dynamic and non-linear changes in environmental factors such as cloud cover, solar radiation intensity, and weather patterns. As a result, the predictive accuracy of these models deteriorates over time, leading to inefficiencies in power grid operations and increased costs for energy providers and end-users.

Therefore, there is a need for a solar irradiance nowcasting system and adaptive maintenance method thereof for the solar irradiance nowcasting model that stay up to date with environmental variations.

### BRIEF SUMMARY OF THE INVENTION

An embodiment of the present invention provides a solar irradiance nowcasting system. The solar irradiance nowcasting system includes a storage unit and a processing unit coupled to each other. The storage unit is configured to store a structured dataset, an unstructured dataset, and a solar irradiance nowcasting model. The processing unit is configured to load the solar irradiance nowcasting model from the storage unit and use the solar irradiance nowcasting model to generate a predicted global horizontal irradiance (GHI) value based on a current sky image. The processing unit is further configured to adaptively maintain the solar irradiance nowcasting model by executing operations including: continuously obtaining recent sky images and recent GHI data, and accumulating the recent sky images and the recent GHI data into the unstructured dataset and the structured dataset, respectively; periodically checking the structured dataset and the unstructured dataset to determine if the accumulated number of the recent sky images and the corresponding recent GHI data reaches a specified threshold; and in response to the accumulated number reaching the specified threshold, resetting the accumulated number, and initiating a retraining process. The retraining process includes retraining the solar irradiance nowcasting model using the recent sky images and the corresponding recent GHI data accumulated in the unstructured dataset and the structured dataset, respectively.

In an embodiment, the solar irradiance nowcasting system further includes an observer unit that is remotely connected to the processing unit. The observer unit includes one or more sky imagers and a GHI sensor. The sky imagers are configured to capture the recent sky images. The GHI sensor is configured to measure the recent GHI data. The processing unit obtains the recent sky images and the recent GHI data from the sky imagers and the GHI sensor, respectively.

In an embodiment, the recent sky images undergo a first preprocessing pipeline before being accumulated into the unstructured dataset, and the recent GHI data undergo a second preprocessing pipeline before being accumulated into the structured dataset.

In an embodiment, the sky images include a first sky imager and a second sky imager. The first sky imager is configured to capture a first set of the recent sky images using a first quality parameter set. The second sky imager is configured to capture a second set of the recent sky images using a second quality parameter set. The first set and the second set of the recent sky images undergo the first preprocessing pipeline using a first preprocessing parameter set and a second preprocessing parameter set, respectively. Additionally, the retraining process further includes retraining a first solar irradiance nowcasting model using the first set of the recent sky images and a first hyperparameter set, and retraining a second solar irradiance nowcasting model using the second set of the recent sky images and a second hyperparameter set.

In an embodiment, the processing unit is further configured to, in response to receiving an inference request associated with the current sky image from a client application, use the solar irradiance nowcasting model to generate the predicted GHI value based on the current sky image, and return the predicted GHI value to the client application.

In an embodiment, the processing unit is further configured to obtain a measured GHI value for the current sky image, evaluate the model performance of the solar irradiance nowcasting model by comparing the predicted GHI value with the measured GHI value, and determine, based on the model performance, whether to initiate the retraining process regardless of the accumulated number of the recent sky images and the corresponding recent GHI data.

In an embodiment, the processing unit determines whether to initiate the retraining process by comparing the model performance with a baseline performance. The baseline performance is defined as the average model performance based on historical data.

In an embodiment, the processing unit is further configured to monitor the data drift between the current sky image and historical sky images, and determine, based on the data drift, whether to initiate the retraining process regardless of the accumulated number of the recent sky images and the corresponding recent GHI data.

In an embodiment, metadata of the recent sky images are stored into the structured dataset as the recent sky images are accumulated into the unstructured dataset. Each piece of the recent GHI data includes a recent GHI value and metadata of the recent GHI value. Additionally, the processing unit is further configured to identify correspondence between the recent sky images and the recent GHI data based on the metadata of the recent sky images and the metadata of the recent GHI values.

In an embodiment, the solar irradiance nowcasting model comprises at least one of a deep CNN-LSTM architecture, a VGG16 architecture, and a ResNet18 architecture.

An embodiment of the present invention provides a method for adaptively maintaining the solar irradiance nowcasting model in a solar irradiance nowcasting system. The method includes continuously obtaining recent sky images and recent global horizontal irradiance (GHI) data, and accumulating the recent sky images and the recent GHI data into the unstructured dataset and the structured dataset, respectively. The method further includes periodically checking the structured dataset and the unstructured dataset to determine if the accumulated number of the recent sky images and the corresponding recent GHI data reaches a specified threshold. The method further includes, in response to the accumulated number reaching the specified threshold, resetting the accumulated number, and initiating a retraining process. The retraining process includes retraining the solar irradiance nowcasting model using the recent sky images and the corresponding recent GHI data accumulated in the unstructured dataset and the structured dataset, respectively. The solar irradiance nowcasting model is used by the solar irradiance nowcasting system to generate a predicted GHI value based on a current sky image.

### BRIEF DESCRIPTION OF THE DRAWINGS

The present invention can be more fully understood by reading the subsequent detailed description and examples with references made to the accompanying drawings, wherein:

FIG. 1 is the system block diagram of a solar irradiance nowcasting system, according to an embodiment of the present disclosure;

FIG. 2 is a schematic diagram illustrating the structure of data accumulated into the unstructured dataset and the structured dataset, according to an embodiment of the present disclosure;

FIG. 3A illustrates an example of a deep CNN-LSTM architecture, according to an embodiment of the present disclosure;

FIG. 3B illustrates an example of a VGG16 architecture, according to an embodiment of the present disclosure;

FIG. 3C illustrates an example of a ResNet18 architecture, according to an embodiment of the present disclosure; and

FIG. 4 is the flow diagram of an additional monitoring process applied in the solar irradiance nowcasting system of FIG. 1, according to an embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

In each of the following embodiments, the same reference numbers represent identical or similar elements or components.

Ordinal terms used in the claims, such as “first,” “second,” “third,” etc., are only for convenience of explanation, and do not imply any precedence relation between one another.

The descriptions provided below for embodiments of devices or systems are also applicable to embodiments of methods, and vice versa.

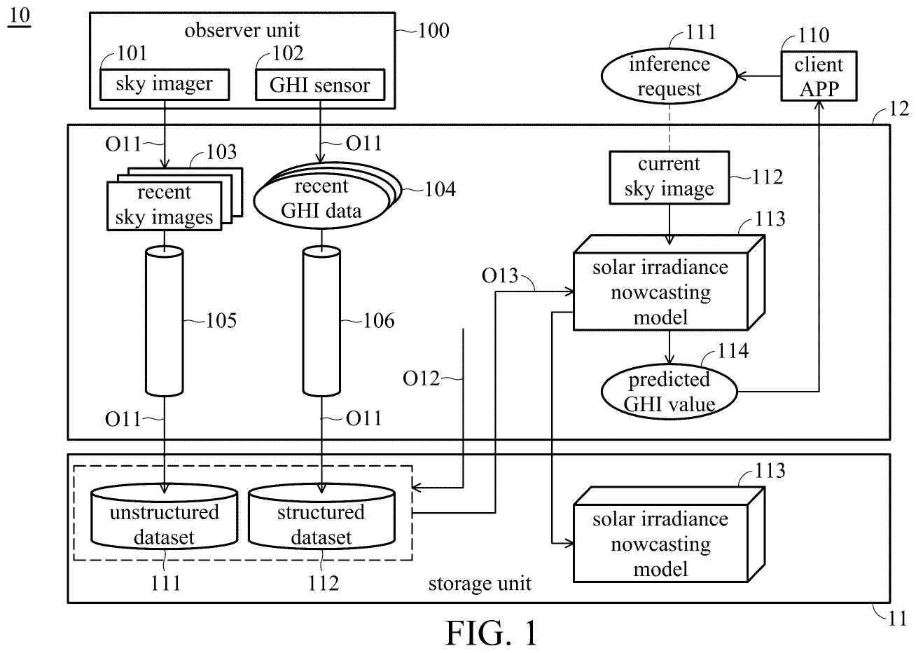

FIG. 1 is the system block diagram of a solar irradiance nowcasting system 10, according to an embodiment of the present disclosure. As shown in FIG. 1, the solar irradiance nowcasting system 10 includes a storage unit 11 and a processing unit 12 coupled to each other. These components will be introduced hereinafter.

The solar irradiance nowcasting system 10 can be a single computer device, such as a personal computer e.g., a desktop or laptop computer) or a server computer running an operating system (e.g., Windows, Mac OS, Linux, UNIX, among others), or a mobile device such as a tablet or smartphone, but the present disclosure is not limited thereto. Alternatively, the solar irradiance nowcasting system 10 can be a computer cluster including multiple computer devices operating in coordination. The components illustrated in FIG. 1, including the storage unit 11 and the processing unit 12, can be deployed on a single computer device or distributed across two or more computer devices, but the present disclosure is not limited thereto.

The storage unit 11 may include one or more non-transitory computer-readable storage media that contain non-volatile memory, such as read-only memory (ROM), electrically-erasable programmable read-only memory (EEPROM), flash memory, or non-volatile random access memory (NVRAM). These storage media may include, but are not limited to, hard disk drives (HDD), solid-state drives (SSD), optical disks, or any combination thereof.

The processing unit 12 may include one or more general-purpose or specialized processors, or a combination thereof, capable of executing instructions. The processing unit 12 may further include volatile memory such as Random Access Memory (RAM), Dynamic Random Access Memory (DRAM), and/or other types of high-speed memory, which work in conjunction with the processors to store and quickly access data and instructions during execution.

In an embodiment, the processing unit 12 includes a Central Processing Unit (CPU) and a Graphics Processing Unit (GPU). A GPU is specifically designed to perform computer graphics calculations and image analysis, making it more efficient for these tasks compared to a general-purpose CPU. Therefore, tasks may be assigned based on the characteristics of the CPU and GPU, such as assigning tasks related to data acquisition or communication with other devices to the CPU and tasks related to computer graphics calculations and image analysis to the GPU. In further embodiments, the processing unit 12 may further include a Neural Processing Unit (NPU), which is optimized for deep learning. Compared to a GPU, an NPU may offer superior computational performance for tasks related to the training and inference of a deep learning model. Therefore, in these embodiments, operations involving model training and inference can be assigned to the NPU to achieve improved efficiency and performance.

As shown in FIG. 1, the storage unit 11 is configured to store an unstructured dataset 111, a structured dataset 112, and a solar nowcasting model 113. The processing unit 12 is configured to load the solar nowcasting model 113 from the storage unit 11 and use the solar nowcasting model 113 to generate a predicted GHI value 114 based on a current sky image 112 as input to the model.

The predicted GHI value 114 represents the prediction on the expected solar irradiation in a specific future time interval based on the current sky image 112. This interval can be adaptively configured according to practical application requirements. For instance, the predicted GHI value 114 may represent the solar irradiance expected 10 minutes, 30 minutes, or 1 hour after the current sky image 112 is captured. Subsequently, the predicted GHI value 114 can be directly integrated into automated systems to enable real-time decision-making and control. In a practical application, the predicted GHI value 114 is transmitted to an energy management system (EMS) to optimize the operation of PV power plants. Based on the predicted GHI value 114, the EMS can adjust the PV inverter settings, manage battery storage systems, or schedule power distribution to maximize energy efficiency. In another application scenario, the predicted GHI value 114 is used by smart grid systems to forecast solar power generation, enabling proactive grid balancing and load management.

Though FIG. 1 merely illustrate a single current sky image 112, it should be appreciated that in some embodiments, the solar nowcasting model 113 can also be used to generate the predicted GHI value 114 based on a sequence of sky images that include the current sky image 112.

Additionally, the processing unit 12 is further configured to execute a method for adaptively maintaining the solar irradiance nowcasting model 113 in the solar irradiance nowcasting system 10. This adaptive maintenance method includes at least operations O11, O12, and O13. Details regarding these operations will be elaborated hereinafter.

In an embodiment, the storage unit 11 stores a computer-executable program (though not shown in FIG. 1), which can be written in any known programming language, such as Python, C++, or Java. This program contains instructions that, when executed by the processing unit 12, cause the solar irradiance nowcasting system 10 to perform the operations, including operations O11, O12, and O13, of the adaptive maintenance method disclosed herein.

As illustrated in FIG. 1, the operation O11 involves continuously obtaining recent sky images 103 and recent global horizontal irradiance (GHI) data 104, and accumulating the recent sky images 103 and the recent GHI data 104 into the unstructured dataset and the structured dataset, respectively. The elements involved in this operation are introduced below.

The recent sky images 103 are time-sequential images captured from a ground-based perspective looking up at the sky. These images provide a visual record of cloud cover, sky conditions, and atmospheric changes over time, forming a time-series dataset that reflects environmental variations affecting solar irradiance.

The recent GHI data 104 are time-series data representing the intensity of global horizontal irradiance measured over time. GHI is physically defined as the total irradiance incident on a horizontal surface on Earth, including two components: direct normal irradiance (DNI) and diffuse horizontal irradiance (DHI). It is the most critical parameter for calculating photovoltaic (PV) power generation, as it directly reflects the solar energy available for conversion into electricity.

In data science, data can generally be categorized as structured or unstructured based on its format and organization. Structured data, such as numerical or tabular information, is highly organized and easily stored in relational databases. In contrast, unstructured data, such as images or videos, lacks a predefined format and requires specialized storage solutions. According to an embodiment of the present disclosure, the unstructured dataset 111 and the structured dataset 112 can be stored in separate locations within the storage unit 11 based on their data characteristics. For example, the unstructured dataset 111, which contains recent sky images 103, may be stored in platforms optimized for unstructured data, such as Amazon S3, Hadoop Distributed File System (HDFS), or Google Cloud Storage. In contrast, the structured dataset 112, containing recent GHI data 104, may be stored in databases designed for structured data, such as MongoDB, Microsoft SQL Server, or Amazon Relational Database Service (RDS). Additionally, the solar irradiance nowcasting model 113 may also be stored alongside the unstructured dataset 111 in the same storage platform for efficient access and management.

Next, the operation O12 involves periodically checking the structured dataset 112 and the unstructured dataset 111 to determine if the accumulated number of the recent sky images 103 and the corresponding recent GHI data 104 reaches a specified threshold. This threshold can be specified based on various criteria. For instance, the threshold may be set as the minimum amount of data required for retraining to ensure model stability and accuracy. Alternatively, the threshold can be determined by considering other factors, such as actual operational requirements, computational resource limitations, or cost-effectiveness, but the present disclosure is not limited thereto.

In response to the accumulated number of the recent sky images 103 and the corresponding recent GHI data 104 reaching the specified threshold, operation 013 is performed, where a retraining process is initiated. If the specified threshold is not met, operation O12 continues to monitor the structured dataset 112 and the unstructured dataset 111 until the condition is satisfied.

For instance, the specified threshold can be predefined as requiring at least 1,000 paired samples of recent sky images 103 and recent GHI data 104. When operation O12 detects that the accumulated number of paired samples meets or exceeds 1000, the solar irradiance nowcasting system 10 proceeds to operation O13, initiating the retraining process.

The retraining process involves retraining the solar irradiance nowcasting model 113 using the recent sky images 103 and the corresponding recent GHI data 104 accumulated in the unstructured dataset 111 and the structured dataset 112, respectively. In other words, the solar irradiance nowcasting model 113 is updated using the newly accumulated data, which incorporates up-to-date temporal patterns and trends captured in the recent sky images 103 and corresponding recent GHI data 104. This retraining process aims to adapt the solar irradiance nowcasting model 113 to changing environmental conditions and improve its predictive accuracy over time. For example, the newly accumulated data may reflect seasonal variations, updated atmospheric conditions, or recent weather patterns, enabling the model to better capture the dynamic characteristics of solar irradiance.

In an embodiment, the solar irradiance nowcasting system 10 may further include an observer unit 100 that is remotely connected to the processing unit 12. The observer unit 100 is used for collecting the data required for model retraining. Specifically, the observer unit 100, as illustrated in FIG. 1, includes a sky imager 101 (or more) and a GHI sensor 102, configured to capture the recent sky images 103 and measure the recent GHI data 104, respectively. Then, the processing unit 12 obtains the recent sky images 103 and the recent GHI data 104 from the sky imager(s) 101 and the GHI sensor 102, respectively.

The sky imager 101 can be any device equipped with imaging capabilities that is configured to capture images of the sky. For example, the sky imager may be a fisheye camera, a panoramic camera, or a conventional digital camera mounted at a fixed location and oriented towards the sky. The sky imager may also include automated scheduling functions for capturing images periodically, such as every 1 to 5 minutes, depending on the system requirements.

The GHI sensor 102 can be any device capable of measuring global horizontal irradiance (GHI). For example, the GHI sensor may include a pyranometer or a silicon-based irradiance sensor, configured to collect solar irradiance data in real-time or at predefined intervals. The GHI sensor may also be equipped with automated data logging capabilities to ensure continuous monitoring of solar irradiance.

In an alternative embodiment, the observer unit 100 does not necessarily include a physical GHI sensor 102 to measure recent GHI data 104. Instead, the recent GHI data 104 can be obtained from open-source datasets or publicly available repositories, such as meteorological databases from sources like the National Renewable Energy Laboratory (NREL) or similar organizations, but the present disclosure is not limited thereto.

In an embodiment, as illustrated in FIG. 1, the recent sky images 103 undergo a first preprocessing pipeline 105 before being accumulated into the unstructured dataset 111, whereas the recent GHI data 104 undergo a second preprocessing pipeline 106 before being accumulated into the structured dataset 112. The preprocessing pipelines 105 and 106 are separate and tailored to the specific characteristics of the data types. For the recent sky images 103, the first preprocessing pipeline 105 may involve steps such as normalizing pixel values, reducing noise through filtering, resizing images to match the model's input dimensions, and segmenting cloud regions using thresholding or deep learning methods, but the present disclosure is not limited thereto. Temporal alignment with the GHI data 104 and feature extraction, such as generating color histograms or texture descriptors, may also be performed to ensure compatibility with downstream tasks. On the other hand, second preprocessing pipeline 106 may include detecting and correcting outliers caused by sensor errors, smoothing temporal fluctuations using techniques like moving averages, normalizing data to a consistent range, and interpolating missing values to maintain continuity, but the present disclosure is not limited thereto.

In a further embodiment, the observer unit 100 includes multiple sky imagers using different quality parameter sets for capturing the sky images, thereby producing sky images with varying quality. The quality parameter sets can include but not limited to resolution parameters, ISO Sensitivity, intrinsic parameters and/or extrinsic parameters. These sky images of different quality are subsequently processed in the first preprocessing pipeline 105 using different preprocessing parameter sets and are later used to retrain distinct solar irradiance nowcasting models with different hyperparameters to meet diverse requirements. The first preprocessing parameter set may include but not limited to parameter settings for normalization, noise reduction, resizing, cloud segmentation, temporal alignment, and/or feature extraction. The second preprocessing parameter set may include but not limited to parameter settings for outlier detection and correction, temporal smoothing, data normalization, and/or interpolation of missing values.

The hyperparameters for retraining the distinct solar irradiance nowcasting models can be determined through various strategies based on the quality parameter sets of the sky images. In some implementations, hyperparameter sets may be manually assigned based on the image quality parameters and subsequently fine-tuned to improve model performance. Alternatively, multiple candidate hyperparameter sets may be predefined based on the image quality parameters, and the processing unit 12 can evaluate these candidates through iterative training to select the optimal set based on performance metrics. In another approach, the processing unit 12 may directly determine the hyperparameters algorithmically by referencing the input data characteristics, including the quality parameter sets.

Furthermore, the observer unit 100 includes at least two sky imagers, hereinafter referred to as the “first sky imager” and the “second sky imager,” respectively. The first sky imager is configured to capture a first set of the recent sky images using a first quality parameter set, whereas the second sky imager is configured to capture a second set of the recent sky images using a second quality parameter set. The first set and the second set of the recent sky images then undergo preprocessing in the first preprocessing pipeline 105 using a first preprocessing parameter set and a second preprocessing parameter set, respectively. During the retraining process, a first instance of the solar irradiance nowcasting model 113, hereinafter referred to as “first solar irradiance nowcasting model”, is retrained using the first set of the recent sky images and a first hyperparameter set, while a second instance of the solar irradiance nowcasting model 113, hereinafter referred to as “second solar irradiance nowcasting model”, is retrained using the second set of the recent sky images and a second hyperparameter set.

For instance, if the first quality parameter set is designed to capture sky images with lower resolution or narrower dynamic range compared to the second quality parameter set, the resulting first set of recent sky images may exhibit lower detail and more noise. Consequently, the preprocessing for this lower-quality data may require additional computational effort, such as advanced noise reduction techniques or sophisticated upscaling methods, to enhance the image quality for effective use in the model. On the other hand, the second set of recent sky images, captured with a higher quality parameter set, may require less intensive preprocessing, as the data is inherently cleaner and more detailed. Accordingly, during retraining, the first solar irradiance nowcasting model associated with the first set of images may require more complex hyperparameters or data augmentation strategies to compensate for the limitations of the lower-quality data. In contrast, the second solar irradiance nowcasting model associated with the higher-quality images may benefit from simpler hyperparameters due to the minimal need for additional correction or enhancement. This strategy ensures that both models are effectively optimized based on the characteristics of their respective datasets, balancing computational efficiency and predictive performance.

In an embodiment, as illustrated in FIG. 1, in response to receiving an inference request 111 associated with the current sky image 112 from a client application 110, the processing unit 12 uses the solar irradiance nowcasting model 113 to generate the predicted GHI value 114 based on the current sky image 112, and return the predicted GHI value 114 to the client application 110.

The client application 110 can be any application that requires solar irradiance nowcasting for its operation. Examples of the client application 110 include energy management systems (EMS) for PV power plants, smart grid controllers for balancing energy loads, agricultural monitoring systems for optimizing irrigation schedules, or weather forecasting platforms for environmental analysis, but the present disclosure is not limited thereto. The inference request 111 can be in the form of an HTTP POST request containing either the sky image itself or the image path pointing to the location of the sky image. Alternatively, the inference request 111 can be submitted via other protocols, such as RPC (Remote Procedure Call) or MQTT (Message Queuing Telemetry Transport), depending on the integration requirements of the client application 110.

The processing unit 11 uses the trained and deployed solar irradiance nowcasting model 113 to provide a real-time forecast, generating the predicted GHI value 114, which is returned to the requesting client application 110. In case of any issues with the inference request 111, such as malformed input, missing parameters, or unsupported formats, the processing unit 11 is configured to return appropriate error codes (e.g., HTTP 400 for bad requests or HTTP 500 for internal server errors) along with a descriptive error message to guide troubleshooting.

Furthermore, the inference stack supporting this real-time inference process can be described as an NGINX reverse proxy that forwards incoming requests to a worker module. The worker handles the POST request body received from the web server, extracts the necessary data (e.g., sky image or image path), and submits it to the solar irradiance nowcasting model 113 for inference. This architecture ensures scalability, reliability, and efficient handling of real-time forecasting requests from multiple client applications.

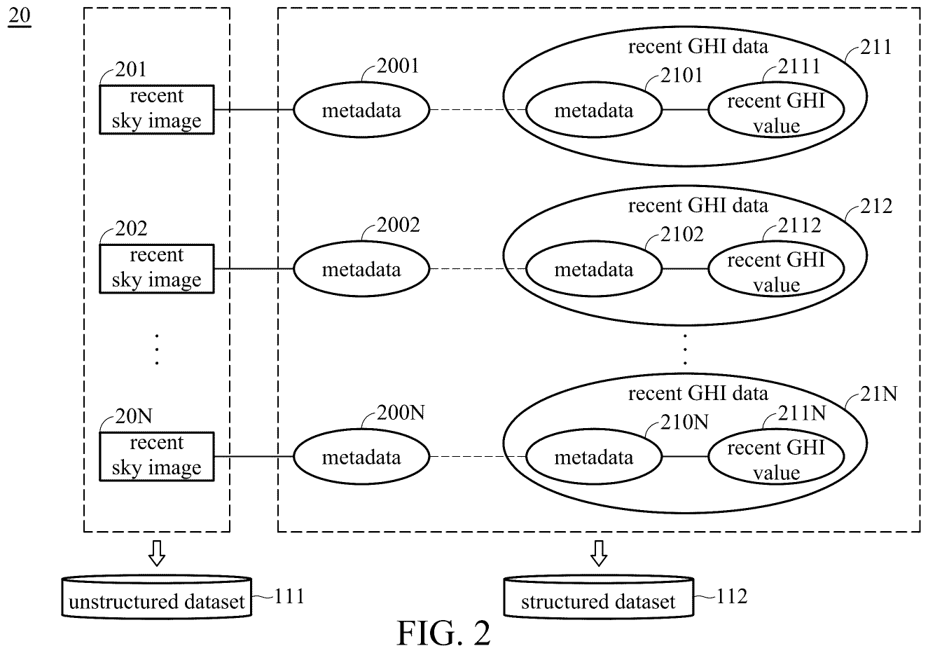

FIG. 2 is a schematic diagram illustrating the structure of data accumulated into the unstructured dataset 111 and the structured dataset 112, according to an embodiment of the present disclosure. As shown in FIG. 2, each piece of the recent GHI data includes a recent GHI value and the metadata of that recent GHI value. For instance, the recent GHI data 211 includes the recent GHI value 2111 and its corresponding metadata 2101, the recent GHI data 212 includes the recent GHI value 2112 and its corresponding metadata 2102, and the recent GHI data 21N includes the recent GHI value 211N and its corresponding metadata 210N. These metadata 2101-210N can include a sequence of characters or encoded information, such as a date-timestamp, to identify the time when the measurements were taken, for example, “2024-11-22, 14:15:00.”

Additionally, it should be noted that the metadata of the recent sky images are stored in the structured dataset 112 as the recent sky images themselves are accumulated into the unstructured dataset 111. For instance, the metadata 2001 of the recent sky image 201, the metadata 2002 of the recent sky image 202, and the metadata 200N of the recent sky image 20N are stored in the structured dataset 112 instead of being stored together with the recent sky images in the unstructured dataset 111. These metadata 2001-200N can include details such as a date-timestamp, a file path pointing to the corresponding recent sky image in the unstructured dataset 111, and/or additional information describing the properties of the image file, such as its resolution or capture settings.

Furthermore, the correspondence, or pairing relationship, between the recent sky images and the recent GHI data is identified based on the metadata of the recent sky images and the metadata of the recent GHI values. More specifically, this correspondence is established to generate paired samples for retraining the solar irradiance nowcasting model 113, where each sky image is paired with the corresponding GHI value representing the expected solar irradiance for a specific future time interval. For instance, if the retraining process is configured to predict solar irradiance 30 minutes into the future, the recent sky image 201 with a timestamp of “2024-11-22, 14:15:00” would be paired with the recent GHI value 2111 that corresponds to the solar irradiance measured at “2024-11-22, 14:45:00.” Similarly, if the retraining is targeting a 1-hour prediction horizon, the same sky image would instead be paired with the recent GHI value measured at “2024-11-22, 15:15:00.” This temporal alignment ensures that the training dataset accurately reflects the temporal relationship between the sky images and the solar irradiance they are used to predict, enabling the retraining process to produce a model capable of generating precise forecasts for future time intervals, thereby helping to maintain the accuracy and adaptability of the solar irradiance nowcasting model under dynamic environmental conditions.

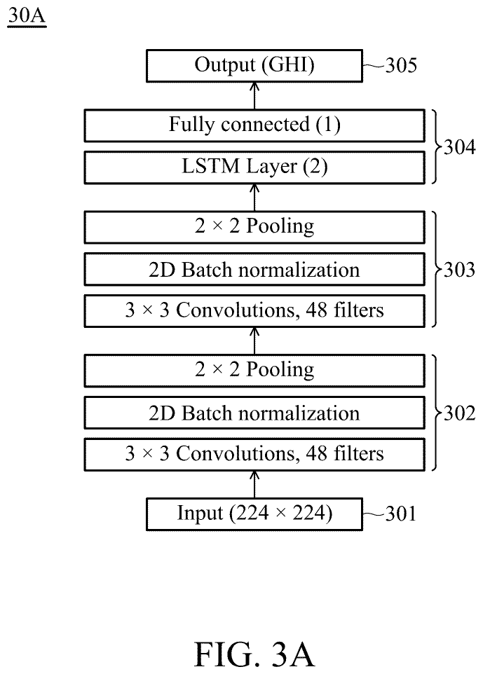

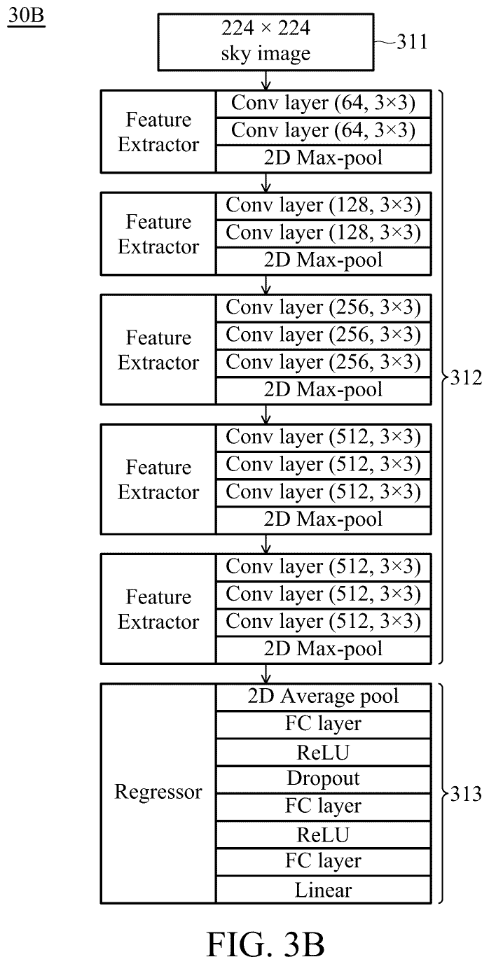

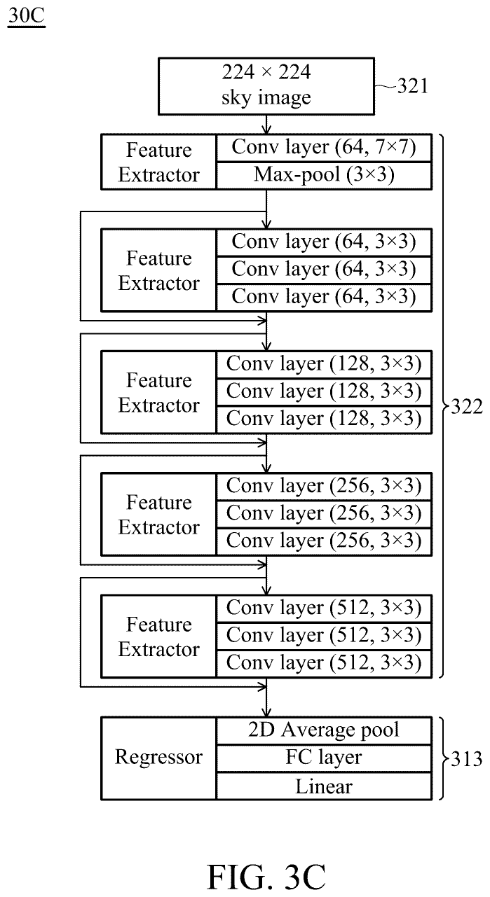

In an embodiment, the solar irradiance nowcasting model 113 includes at least one of a deep CNN-LSTM architecture, a VGG16 architecture, and a ResNet18 architecture. These deep learning architectures are suitable for different application scenarios, depending on factors such as the complexity of the input data, the required temporal resolution, and the computational resources available. Each of these deep learning architectures will be elaborated with reference to FIGS. 3A-3C, respectively.

FIG. 3A illustrates an example of a deep CNN-LSTM architecture 30A, according to an embodiment of the present disclosure. The deep CNN-LSTM architecture 30A combines convolutional layers for spatial feature extraction and LSTM (Long Short-Term Memory) layers for temporal sequence modeling, making it suitable for predicting solar irradiance values based on a sequence of sky images.

In the example illustrated in FIG. 3A, the input sky image sequence 301 is a sequence of 224×224-pixel images that serves as the input to the deep CNN-LSTM architecture 30A. This input sky image sequence 301 is first processed by two convolutional learning blocks 302 and 303, which are designed to progressively extract spatial features from the input sky image 301. The first convolutional learning block 302 includes a 3×3 convolutional layer with 24 filters, followed by 2D batch normalization to accelerate the training process and increase robustness, and a 2×2 max pooling layer with a stride of 2 to reduce the spatial dimensions of the feature maps. Similarly, the second convolutional learning block 303 applies a 3×3 convolutional layer with 48 filters, followed by 2D batch normalization and a 2×2 max pooling layer. The output of the second convolutional learning block 303 is then passed to the regression block 304, which includes two LSTM layers for capturing temporal dependencies between sequential sky images. These LSTM layers are followed by a fully connected layer that maps the learned features to the output GHI value 305, representing the predicted GHI derived from the input sky image sequence 301.

The deep CNN-LSTM architecture 30A is particularly suitable for scenarios requiring predictions based on temporal patterns in sky image sequences. For example, it can be applied in systems where multiple sky images taken at regular intervals are available, allowing the model to leverage both spatial features and temporal dependencies to improve forecast accuracy. This architecture is especially effective in environments with rapidly changing weather conditions, where sequential image analysis is crucial for capturing dynamic changes in cloud cover and solar irradiance patterns.

FIG. 3B illustrates an example of a VGG16 architecture 30B, according to an embodiment of the present disclosure. The VGG16 architecture 30B is a deep convolutional neural network designed for spatial feature extraction, with a consistent layer structure that systematically increases the complexity of learned features as the input data progresses through the network.

In the example illustrated in FIG. 3B, the input sky image 311, with a resolution of 224×224 pixels, is passed through a series of feature extractors 312, each including convolutional layers followed by pooling layers. The first feature extractor applies two 3×3 convolutional layers with 64 filters each, followed by a 2×2 max pooling layer with a stride of 2, reducing the spatial dimensions of the feature maps while preserving essential features. The subsequent feature extractors progressively increase the number of filters in the convolutional layers, doubling at each stage: from 64 to 128, 128 to 256, and finally to 512 filters in the last two feature extractors. After feature extraction, the output of the last feature extractor is passed to the regressor 313, which begins with a 2D average pooling layer to reduce the spatial dimensions to a fixed size. The pooled features are then processed through fully connected (FC) layers, interspersed with ReLU activation functions and a dropout layer for regularization, to prevent overfitting. Finally, a linear layer outputs the predicted GHI value based on the extracted features.

The VGG16 architecture 30B is particularly suitable for scenarios requiring robust spatial feature extraction from individual sky images. For instance, it is well-suited for applications where temporal dependencies are less critical, such as systems analyzing static weather conditions or making short-term predictions based on single frames. The deep and structured design allows the VGG16 architecture 30B to effectively capture intricate spatial patterns in the sky images, such as cloud textures and formations, which are crucial for accurate solar irradiance nowcasting.

FIG. 3C illustrates an example of a ResNet18 architecture 30C, according to an embodiment of the present disclosure. The ResNet18 architecture 30C is a deep convolutional neural network designed to effectively extract spatial features while addressing the vanishing gradient problem in deep networks through the use of residual connections.

In the example illustrated in FIG. 3C, the input sky image 321, with a resolution of 224×224 pixels, is passed through a sequence of feature extractors 322. The first feature extractor includes a 7×7 convolutional layer followed by a 3×3 max pooling layer with a stride of 2, which reduces the spatial dimensions of the input image and extracts initial spatial features. Subsequent feature extractors are organized as residual blocks, each including three convolutional layers. The number of filters in the convolutional layers doubles with each successive residual block, progressing from 64 filters in the first residual block to 128, 256, and eventually 512 filters in the final residual block. These residual blocks are connected with skip connections, which forward the residual mapping from the input of the block to its output. This mechanism allows the network to learn residual functions instead of direct mappings, enabling deeper networks to be trained more efficiently and effectively by mitigating the vanishing gradient problem. After the last residual block, a global average pooling layer of the regressor 313 computes the average of each feature map, producing a fixed-size feature vector regardless of the dimensions of the input sky image 321. This feature vector is then passed through a fully connected layer with a linear activation function to generate continuous predicted GHI values, supporting different forecast horizons.

The ResNet18 architecture 30C is particularly suitable for scenarios requiring robust spatial feature extraction while maintaining computational efficiency. The use of residual connections makes it well-suited for deep architectures where gradient flow and training stability are critical. This architecture excels in applications involving complex cloud patterns or noisy sky images, as the residual connections improve feature learning and model generalization. Additionally, the capability to adapt to varying input image resolutions makes the ResNet18 architecture 30C ideal for solar irradiance nowcasting systems that process data from diverse sources or formats.

The above three exemplary deep learning architectures can be trained using a gradient descent optimizer or any variant thereof, such as the Adam (Adaptive Moment Estimation) optimizer, with a loss function that represents the difference between the predicted values and the ground truth, such as Mean Squared Error (MSE) or Mean Absolute Error (MAE), but the present disclosure is not limited thereto.

In addition to the aforementioned approach based on the accumulation of training samples, other monitoring mechanisms may be used in some embodiments to trigger the retraining process of the solar irradiance nowcasting model 113. In other words, as long as specific conditions are met, the retraining process for the solar irradiance nowcasting model 113 will be forcibly initiated regardless of whether the recent sky images 103 and recent GHI data 104 accumulated in the unstructured dataset 111 and the structured dataset 112 reach the specified threshold. These monitoring mechanisms will be proposed and explained below.

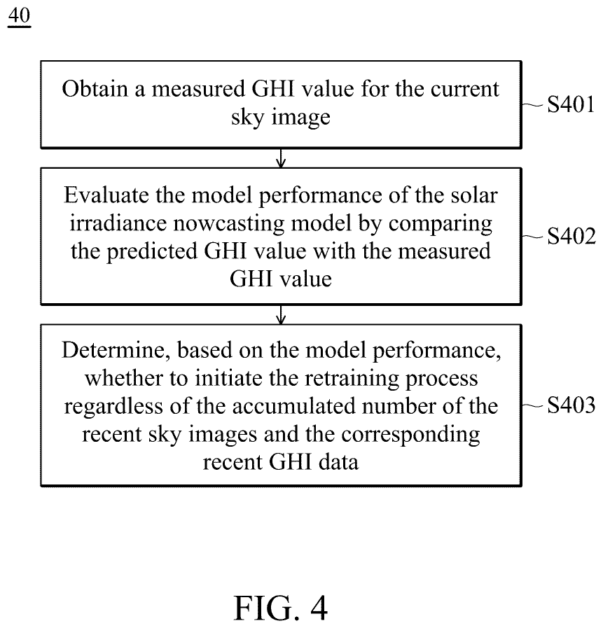

FIG. 4 is the flow diagram of an additional monitoring process 40 applied in the solar irradiance nowcasting system 10 of FIG. 1, according to an embodiment of the present disclosure. As shown in FIG. 4, the monitoring process 40 includes steps S401-S403.

In step S401, the processing unit 12 obtains a measured GHI value for the current sky image 112. For instance, if the retraining process is configured to predict solar irradiance 30 minutes into the future, the measured GHI value corresponds to the actual solar irradiance measured 30 minutes after the current sky image 112 was captured. The measured GHI value can be obtained from the GHI sensor 102 of the observer unit 100. Alternatively, it can be obtained from open-source datasets or publicly available repositories, such as meteorological databases provided by organizations like the National Renewable Energy Laboratory (NREL) or similar institutions, but the present disclosure is not limited thereto.

In step S402, the processing unit 12 evaluates the model performance of the solar irradiance nowcasting model 113 by comparing the predicted GHI value 114 with the measured GHI value. The measured GHI value serves as the ground truth for assessing the accuracy of the predictions made by the solar irradiance nowcasting model 113. A smaller difference between the measured and predicted GHI values indicates better model performance, whereas larger discrepancies signify reduced accuracy. The model performance can be quantified using any mathematical metric that represents the difference between the predicted and measured values, such as Mean Absolute Error (MAE), Mean Squared Error (MSE) or other metrics, but the present disclosure is not limited thereto.

In step S403, the processing unit 12 determines, based on the model performance, whether to initiate the retraining process regardless of the accumulated number of the recent sky images 103 and the corresponding recent GHI data 104. For instance, if the model performance drops below a certain level, such as an MAE exceeding a predefined threshold, it may indicate that the deployed solar irradiance nowcasting model 113 is no longer accurately reflecting current environmental conditions. Under such circumstances, the processing unit 12 manages to update the solar irradiance nowcasting model 113 and restore its predictive accuracy by forcibly triggering the retraining process.

In a further embodiment of step S402, the processing unit 12 compares the model performance with a baseline performance, which is defined as an average model performance based on historical data. Specifically, the model performance of the deployed solar irradiance nowcasting model 113 is continuously monitored and recorded, forming a repository of historical data that reflects the model's prior accuracy and behavior under varying conditions. For instance, if the current model performance deviates significantly from the baseline performance, such as when the Mean Absolute Error (MAE) increases beyond a predefined threshold compared to the historical average, it may indicate that the model is no longer accurately reflecting current environmental conditions. In such cases, the processing unit 12 triggers the retraining process to recalibrate the model, ensuring it regains the predictive accuracy and adaptability to current conditions.

The monitoring process 40 ensures that the solar irradiance nowcasting model 113 remains reliable and adaptable to evolving environmental conditions, even if the accumulated number of recent sky images 103 and recent GHI data 104 has not yet reached the specified threshold for regular retraining.

In another embodiment, the processing unit 12 further monitors the data drift between the current sky image and historical sky images. Data drift refers to significant changes in the statistical properties or feature distributions of incoming data compared to historical data, which may indicate shifts in environmental conditions, sensor behavior, or other factors impacting the input sky image's characteristics.

Subsequently, the processing unit 12 determines, based on the data drift, whether to initiate the retraining process of the solar irradiance nowcasting model 113, regardless of the accumulated number of recent sky images 103 and the corresponding recent GHI data 104. For instance, if the data drift exceeds a predefined threshold, such as a substantial deviation in the pixel intensity distribution of the current sky image compared to the historical sky images, it may signify that the current environmental conditions, such as cloud cover or atmospheric properties, have diverged significantly from those represented in the existing model. Under such circumstances, the processing unit 12 triggers the retraining process to adapt the solar irradiance nowcasting model 113 to the new data patterns, ensuring it remains accurate and reliable for future predictions.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A solar irradiance nowcasting system, comprising:
a storage unit, configured to store a structured dataset, an unstructured dataset, and a solar irradiance nowcasting model;
a processing unit, coupled to the storage unit, and configured to load the solar irradiance nowcasting model from the storage unit and use the solar irradiance nowcasting model to generate a predicted global horizontal irradiance (GHI) value based on a current sky image;
wherein the processing unit is further configured to adaptively maintain the solar irradiance nowcasting model by executing operations comprising:
continuously obtaining recent sky images and recent GHI data, and accumulating the recent sky images and the recent GHI data into the unstructured dataset and the structured dataset, respectively;
periodically checking the structured dataset and the unstructured dataset to determine if an accumulated number of the recent sky images and the corresponding recent GHI data reaches a specified threshold; and
in response to the accumulated number reaching the specified threshold, resetting the accumulated number, and initiating a retraining process, wherein the retraining process includes retraining the solar irradiance nowcasting model using the recent sky images and the corresponding recent GHI data accumulated in the unstructured dataset and the structured dataset, respectively.

2. The solar irradiance nowcasting system as claimed in claim 1, further comprising an observer unit that is remotely connected to the processing unit, wherein the observer unit comprises:
one or more sky imagers, configured to capture the recent sky images; and
a GHI sensor, configured to measure the recent GHI data;
wherein the processing unit obtains the recent sky images and the recent GHI data from the one or more sky imagers and the GHI sensor, respectively.

3. The solar irradiance nowcasting system as claimed in claim 2, wherein the recent sky images undergo a first preprocessing pipeline before being accumulated into the unstructured dataset, and the recent GHI data undergo a second preprocessing pipeline before being accumulated into the structured dataset.

4. The solar irradiance nowcasting system as claimed in claim 3, wherein the one or more sky imagers comprises:
a first sky imager, configured to capture a first set of the recent sky images using a first quality parameter set; and
a second sky imager, configured to capture a second set of the recent sky images using a second quality parameter set;
wherein the first set and the second set of the recent sky images undergo the first preprocessing pipeline using a first preprocessing parameter set and a second preprocessing parameter set, respectively; and
wherein the retraining process further includes retraining a first solar irradiance nowcasting model using the first set of the recent sky images and a first hyperparameter set, and retraining a second solar irradiance nowcasting model using the second set of the recent sky images and a second hyperparameter set.

5. The solar irradiance nowcasting system as claimed in claim 1, wherein the processing unit is further configured to, in response to receiving an inference request associated with the current sky image from a client application, use the solar irradiance nowcasting model to generate the predicted GHI value based on the current sky image, and return the predicted GHI value to the client application.

6. The solar irradiance nowcasting system as claimed in claim 1, wherein the processing unit is further configured to:
obtain a measured GHI value for the current sky image;
evaluate a model performance of the solar irradiance nowcasting model by comparing the predicted GHI value with the measured GHI value; and
determine, based on the model performance, whether to initiate the retraining process regardless of the accumulated number of the recent sky images and the corresponding recent GHI data.

7. The solar irradiance nowcasting system as claimed in claim 6, wherein the processing unit determines whether to initiate the retraining process by comparing the model performance with a baseline performance, wherein the baseline performance is defined as an average model performance based on historical data.

8. The solar irradiance nowcasting system as claimed in claim 1, wherein the processing unit is further configured to:
monitor a data drift between the current sky image and historical sky images; and
determine, based on the data drift, whether to initiate the retraining process regardless of the accumulated number of the recent sky images and the corresponding recent GHI data.

9. The solar irradiance nowcasting system as claimed in claim 1, wherein metadata of the recent sky images are stored into the structured dataset as the recent sky images are accumulated into the unstructured dataset;
wherein each piece of the recent GHI data comprises a recent GHI value and metadata of the recent GHI value; and
wherein the processing unit is further configured to identify correspondence between the recent sky images and the recent GHI data based on the metadata of the recent sky images and the metadata of the recent GHI values.

10. The solar irradiance nowcasting system as claimed in claim 1, wherein the solar irradiance nowcasting model comprises at least one of a deep CNN-LSTM architecture, a VGG16 architecture, and a ResNet18 architecture.

11. A method for adaptively maintaining a solar irradiance nowcasting model in a solar irradiance nowcasting system, comprising:
continuously obtaining recent sky images and recent global horizontal irradiance (GHI) data, and accumulating the recent sky images and the recent GHI data into the unstructured dataset and the structured dataset, respectively;
periodically checking the structured dataset and the unstructured dataset to determine if an accumulated number of the recent sky images and the corresponding recent GHI data reaches a specified threshold; and
in response to the accumulated number reaching the specified threshold, resetting the accumulated number, and initiating a retraining process, wherein the retraining process includes retraining the solar irradiance nowcasting model using the recent sky images and the corresponding recent GHI data accumulated in the unstructured dataset and the structured dataset, respectively;
wherein the solar irradiance nowcasting model is used by the solar irradiance nowcasting system to generate a predicted GHI value based on a current sky image.

12. The method as claimed in claim 11, further comprising:
capturing the recent sky images using one or more sky imagers;
measuring the recent GHI data using a GHI sensor; and
obtaining the recent sky images and the recent GHI data from the one or more sky imagers and the GHI sensor, respectively.

13. The method as claimed in claim 12, wherein the recent sky images undergo a first preprocessing pipeline before being accumulated into the unstructured dataset, and the recent GHI data undergo a second preprocessing pipeline before being accumulated into the structured dataset.

14. The method as claimed in claim 11, wherein the one or more sky imagers comprises a first sky imager and a second sky imager, and the method further comprising:
by the first sky imager, capturing a first set of the recent sky images using a first quality parameter set; and
by the second sky imager, capturing a second set of the recent sky images using a second quality parameter set;
wherein the first set and the second set of the recent sky images undergo the first preprocessing pipeline using a first preprocessing parameter set and a second preprocessing parameter set, respectively; and
wherein the retraining process further includes retraining a first solar irradiance nowcasting model using the first set of the recent sky images and a first hyperparameter set, and retraining a second solar irradiance nowcasting model using the second set of the recent sky images and a second hyperparameter set.

15. The method as claimed in claim 11, further comprising:
in response to receiving an inference request associated with a current sky image from a client application, use the solar irradiance nowcasting model to generate a predicted GHI value based on the current sky image, and return the predicted GHI value to the client application.

16. The method as claimed in claim 11, further comprising:
obtaining a measured GHI value for the current sky image;
evaluating a model performance of the solar irradiance nowcasting model by comparing the predicted GHI value with the measured GHI value; and
determining, based on the model performance, whether to initiate the retraining process regardless of the accumulated number of the recent sky images and the corresponding recent GHI data.

17. The method as claimed in claim 16, wherein the step of determining whether to initiate the retraining process includes comparing the model performance with a baseline performance, wherein the baseline performance is defined as an average model performance based on historical data.

18. The method as claimed in claim 11, further comprising:
monitoring a data drift between the current sky image and historical sky images; and
determining, based on the data drift, whether to initiate the retraining process regardless of the accumulated number of the recent sky images and the corresponding recent GHI data.

19. The method as claimed in claim 11, wherein metadata of the recent sky images are stored into the structured dataset as the recent sky images are accumulated into the unstructured dataset;
wherein each piece of the recent GHI data comprises a recent GHI value and metadata of the recent GHI value; and
wherein correspondence between the recent sky images and the recent GHI data is identified based on the metadata of the recent sky images and the metadata of the recent GHI values.

20. The method as claimed in claim 11, wherein the solar irradiance nowcasting model comprises at least one of a deep CNN-LSTM architecture, a VGG16 architecture, and a ResNet18 architecture.
